(19) United States
(12) Patent Application Publication
(10) Pub. No.: US 2014/0248394 A1
(43) Pub. Date: Sep. 4, 2014

(54) Composition Comprising a Calcium Salt, Preparation Process and Use in Food Products

(71) Applicants: Stéphane Cantais, Antony (FR); Camille Corbier, Paris (FR); Olivier Noble, Orsay (FR)

(72) Inventors: Stéphane Cantais, Antony (FR); Camille Corbier, Paris (FR); Olivier Noble, Orsay (FR)

(73) Assignee: COMPAGNIE GERVAIS DANONE, Paris (FR)

(21) Appl. No.: 14/351,452

(22) PCT Filed: Oct. 14, 2011
(86) PCT No.: PCT/IB2011/002854

§ 371 Date: Apr. 11, 2014

(51) Int. Cl. A23C 9/13; A23C 9/123; A23L 1/304

(52) U.S. Cl. CPC A23C 9/1322; A23L 1/304; A23C 9/123
USPC 426/43; 426/648; 426/580

(57) ABSTRACT

The invention concerns a composition comprising a calcium salt and its preparation process. The calcium salt is a salt of Ca²⁺ ions and PO4³⁻ ions or HPO4²⁻. The composition is appropriate for introduction in food products.

The invention concerns a composition comprising a calcium salt, said composition being appropriate for supplementing food products with calcium.

Calcium is an important nutrient that is naturally present in various food products, for example in milk. Various food products are supplemented with calcium. For example some fermented milk products are supplemented with Calcium. Calcium can be typically introduced in food products in the form to tricalcium citrate (TCC). One way of introducing TCC in fermented milk products is to prepare a white mass and then to add a composition, referred to as fruit preparation, comprising additives including the TCC. Said fruit preparations are typically prepared before the production of the white mass and have a high impact on the organoleptic properties of the fermented milk product, especially on the taste. Accordingly fruit preparations typically have an acidic pH to provide the desired taste. As the pH impacts the taste, it is required that the pH of the fruit preparation be stable over time, to avoid change of taste during storage and/or transportation of the fruit preparation and thus to allow some flexibility in the supply and/or or manufacturing chain, as well as to avoid change of taste during the shelf life of the fermented milk product. Stability and organoleptic properties are even more of a challenge for fruit preparations and/or fermented milk products having a high concentration of calcium. TCC has limitations in providing pH stability and is considered as expensive.

There is thus a need for other calcium supplementation compounds, for example that allow pH stability of fruit preparations with good organoleptic properties such as taste.

Document U.S. Pat. No. 4,784,871 describes fruit preparations supplemented with calcium, to be added to yogurts. The fruit preparations have a pH lower than 4.6 and comprise tricalcium phosphate, dicalcium phosphate, or a mixture of tricalcium phosphate and dicalcium phosphate. Other alternative sources are listed col. 3 lines 33-35, and include monocalcium phosphate. The document discloses col. 2 lines 59-64 that the pH is controlled with citric acid. However such fruit preparations do not present a time-stable pH and/or the quantity of citric acid needed to obtain a time-stable pH is too important and provides a pH that is too acidic. As a result yogurts and/or processes to prepare such yogurts are impacted because the final product is too acid, and/or because the white mass must have a high pH, and/or because the fruit preparations require urgent introduction in the white mass due to low pH stability. There is thus a need for better compositions that allow a better yogurt preparation process. There is also a need for calcium phosphate supplemented products with better organoleptic properties.

Document U.S. Pat. No. 5,820,903 describes the addition to a fermented dairy product of a slurry comprising tricalcium phosphate particles, water and citric acid. As a result yogurts and/or processes to prepare such yogurts are impacted because the final product is too acid, and/or because the white mass must have a high pH, and/or because the slurry requires urgent introduction in the white mass due to low pH stability. There is thus a need for better compositions that allow a better yogurt preparation process. There is also a need for calcium phosphate supplemented products with better organoleptic properties.

The invention addresses at least one of the needs or problems above, with a composition comprising:
water,
a first salt comprising Ca²⁺ ions and PO₄³⁻ ions or HPO₄²⁻ ions, optionally in a hydrated or hydroxylated form,
an acidification compound selected from phosphoric acid or a second salt of Ca²⁺ ions and H₂PO₄⁻ ions, optionally in a hydrated form,
a stabilizing system having at least one stabilizer,
optionally at least one organoleptic modifier selected from aromas, flavors, sugars, sweetening agents, coloring agents, fruits, fruit extracts, cereals and/or cereal extracts, wherein:
the total amount by weight of calcium from the first salt and the second salt, if present, is from 0.1% to 10%, preferably from 0.5% to 4.5%, preferably from 1% to 3%, and
the molar ratio between the first salt and the acidification compound is from 0.1 to 2, preferably from 0.1 to 1, preferably from 0.25 to 0.75.

It is mentioned that the composition of the invention can be referred to as a fruit preparation and can be used as a fruit preparation in fermented milk products production.

The invention also concerns a process for preparing the composition of the invention, and to intermediate mixtures useful to prepare such compositions.

The invention also concerns the use of the composition in food products. The invention also concerns a process of preparing food products, comprising the step of preparing the composition of the invention and the step of adding the composition in a food product.

### Definitions

In the present application sizes of particles and repartitions thereof refer to average sizes and/or median sizes (D₅₀) or upper cuts (D₉₀) by number. Such sizes and repartitions can be measured in the composition or in powder form by laser diffraction, for example with Malvern Mastersizer 2000 equipment. One can also use values provided by suppliers of ingredients.

### First Salt

The composition comprises a first salt comprising Ca²⁺ ions and PO₄³⁻ ions, optionally in a hydrated or hydroxylated form. Said first salts are known by the one skilled in the art. The first salt can be for example tricalcium phosphate (TCP) of formula Ca₃(PO₄)₂ or hydroxyapatite of formula Ca₅(PO₄)₃(OH), but usually written Ca₁₀(PO₄)₆(OH)₂. TCP is however preferred. In another embodiment the first salt can be dicalcium phosphate of formula CaHPO₄ or dicalcium phosphate dihydrate of formula CaHPO₄.2H₂O.

The first salt can be typically provided in the composition in the form of a powder.

It is mentioned that the first salt has typically a low solubility in the composition. The first salt is typically provided in a powder form. The first salt is typically present in the composition in the form of particles. Thus the composition is typically a suspension in water of particles of the first salt. In one embodiment at least a part of the first salt is thus in the form of particles. The particles, in the composition and/or in the powder form, preferably have a size repartition with a D₉₀ size of lower than 20 μm, preferably of lower than 10 μm. The particles, in the composition and/or in the powder form, preferably have a size repartition with a D₅₀ size of lower than 10 μm, preferably of lower than 5 μm. It is believed that such sizes can help in avoiding degraded organoleptic properties such as chalky, powdery, astringent, bitter and/or bad taste.

The amount of first salt in the composition can be typically of from 0.1% to 10% by weight, preferably of from 0.5% to 8%.

### Acidification Compound

The composition comprises an acidification compound selected from phosphoric acid or a second salt of Ca²⁺ ions and H₂PO₄⁻ ions, optionally in a hydrated form. Said second salts are known by the one skilled in the art. The second salt can be for example a monocalcium phosphate salt (MCP) such as monocalcium phosphate of formula Ca(H₂PO₄)₂ or monocalcium phosphate monohydrate of formula Ca(H₂PO₄)₂.H₂O.

The amount of acidification compound in the composition can be typically of from 0.5% to 10% by weight.

Phosphoric acid can be provided in the form of an aqueous solution. The second salt can be provided in the form of a powder.

It is mentioned that the second salt has typically a high solubility in the composition. Thus the second salt is typically present in the composition in the form of a solution or in mix solution and dispersion form.

### Stabilizing System

The composition of the invention typically comprises a stabilizing system, having at least one stabilizer. The stabilizing system can comprise at least two stabilizers. Such stabilizers are known by the one skilled in the art. They typically help in avoiding phase separation of solids, for examples of fruits or fruits extracts and/or in avoiding syneresis. They typically provide some viscosity to the composition, for example a viscosity (Bostwick viscosity at 20° C.) of from 1 to 20 cm/min, preferably of from 4 to 12 cm/min.

The stabilizing system or the stabilizer can for example be a starch, a pectin, a guar, a xanthan, a carrageenan, a locust bean gum, or a mixture thereof. The amount of stabilizing system is typically of from 0.5 to 5% by weight.

### Organoleptic Modifiers

The composition optionally comprises organoleptic modifiers. Such ingredients are known by the one skilled in the art.

The organoleptic modifiers can be for example flavors (or “aroma”), sugars, sweetening agents, coloring agents, fruits, fruit extracts, cereals and/or cereal extracts.

Examples of sweetening agents are ingredients referred to as High Intensity Sweeteners, such as sucralose, acesulfamK, aspartam, saccharine, rebaudioside A or other steviosides or stevia extracts.

Examples of flavors include for example strawberry flavor, apricot flavor, vanilla flavor, peach flavor, cream flavor, sweet boosters, flavor modifiers, flavor improvers, sweet modifiers, sweetness enhancers, masking flavors, and mixtures thereof. Such flavors are known by the one skilled in the art.

Useful fruits or fruit extracts are known by the one skilled in the art. Examples of fruits or fruit extracts include for example:
frozen fruit cubes, for example 10 mm fruit cubes, for example Individual Quick Frozen fruit cubes, for example strawberry, peach, apricot, mango, apple or pear fruit cubes or mixtures thereof,
Aseptic fruit cubes, for example 10 mm fruit cubes, for example strawberry, peach, apricot, mango, apple or pear fruit cubes or mixtures thereof,
fruit purees, for example fruit purees concentrated from 2 to 5 times, preferably 3 times, for example aseptic fruit purees, for example strawberry, peach, apricot, mango, raspberry, blueberry or apple fruit purees or mixtures thereof,
single aseptic fruit purees, for example strawberry, raspberry, peach, apricot, blueberry or apple single aseptic fruit purees or mixture thereof,
frozen whole fruits, for example Individual Quick Frozen whole fruits, for example blueberry, raspberry or blackberry frozen whole fruits, or mixtures thereof, or - mixtures thereof.

Other examples of organoleptic modifiers include cacao, chocolate, coffee, nuts such as almonds, walnuts or chestnuts, or extracts thereof or flavors thereof.

The organoleptic modifiers and the amounts thereof are typically such that the composition has a brix degree of from 1 to 65 brix.

### Water

The composition comprises water. It is mentioned that a part of the water can come from ingredients used to prepare the composition, for example from fruits or fruit extracts or from a phosphoric acid solution. The amount of water in the composition is preferably of from 10 to 99%, preferably of from 10 to 87%.

### Further Ingredients

The composition of the invention can comprise further ingredients, different from the first salts, the acidification compound, the stabilizing system, the water and the organoleptic modifiers. Examples of such further ingredients include some nutrients and/or vitamins. The composition can for example comprise vitamin D, vitamin B and/or vitamin E. The amounts in the composition of such further ingredients can be adjusted for meeting desired amount in a food product.

### Other Features of the Composition

In one preferred embodiment the first salt is tricalcium phosphate and the acidification compound is monocalcium phosphate or monocalcium phosphate monohydrate.

In a preferred embodiment the pH, measured at 20° C., of the composition is typically of from 2.5 to 5, preferably of from 2.8 to 4.2. The amount of acidification compound can be adjusted thereto.

In the composition the total amount by weight of calcium from the first salt and from the second salt, if present, is of from 0.1% to 10%, preferably from 0.5% to 4.5%, preferably from 1 to 3%. This amount can be adjusted by adjusting the amount of first salt and, if the acidification compound is the second salt, by adjusting also the amount of second salt. The amount of calcium in the composition can be adjusted for meeting desired amount in a food product. In adjusting one typically takes into account the calcium content already present in the food product, for example the calcium content of milk.

In the composition the molar ratio between the first salt and the acidification compound is of from 0.1 to 2, preferably from 0.1 to 1, preferably from 0.25 to 0.75. If the acidification compound is phosphoric acid the molar ratio is preferably from 1 to 2. If the acidification compound is the second salt the molar amount is preferably from 0.1 to 1, preferably from 0.25 to 0.75. This molar ratio can be adjusted by adjusting the amounts of first salt and acidification compound.

### Process

The composition of the invention can be prepared be any appropriate process. The processes typically involve mixing the ingredients of the composition.

A typical process for preparing the composition comprises the steps of:
Step 1) mixing the first salt and at least a part of the water to obtain an aqueous premix,
Step 2) mixing the aqueous premix, the stabilizing system, the optional organoleptic modifiers, and the remaining water if any.
   If the acidification compound is the second salt, then the acidification compound can be typically mixed at step 1). If the acidification compound is phosphoric acid, then the acidification compound can be mixed at step 1) or step 2).

In the embodiment where the acidification compound is the second salt, such as monocalcium phosphate or monocalcium phosphate monohydrate, and the first salt is tricalcium phosphate, the aqueous premix is typically a slurry wherein the second salt is solubilized and the first salt is not or is partially solubilized and is in the form of a dispersion. The amount by weight of water in the aqueous premix is preferably of at least three times the amount by weight of the first salt and second salt if present. One can add all the water of the composition at this stage, or a part of water, for example up to 50% of the water of the composition.

It is mentioned that the organoleptic modifiers can be added at different stages. In one embodiment flavors and/or coloring agents are added at the end of the process, while fruits and/or sugar are added earlier.

It is mentioned that the process can comprise a heat treatment step such as a pasteurization step. Pasteurization is typically performed at step 2), once the aqueous premix, the stabilizing system, and the optional organoleptic modifiers such as fruits or sugar have been mixed. Of course the process can comprise a cooling step.

In one embodiment the process comprises the following steps:
Step 1) preparing a dispersion in water of tricalcium phosphate and monocalcium phosphate or monocalcium phosphate monohydrate, to obtain an aqueous premix,
Step 2a) preparing a mix of fruits and/or sugar and water,
Step 2b) mixing the mix of step 2a) and the aqueous premix of step 1),
Step 2c) adding the stabilizing system,
Step 2d) pasteurizing, for example at a temperature of from 85 to 95° C., during 1 to 10 minutes,
Step 2e) optionally adding coloring agents and/or flavors,
Step 2f) cooling to room temperature or below.

In one embodiment the process comprises the following steps:
Step 1) preparing a dispersion in water of tricalcium phosphate to obtain an aqueous premix,
Step 2a) preparing a mix of fruits and/or sugar and water,
Step 2b) mixing the mix of step 2a) and the aqueous premix of step 1),
Step 2c) adding the stabilizing system,
Step 2d) pasteurizing, for example at a temperature of from 85 to 95° C., during 1 to 10 minutes,
Step 2e′) adding phosphoric acid
Step 2f′) optionally adding coloring agents and/or flavors
Step 2g′) cooling to room temperature or below.

It is mentioned that the composition of the invention is then typically conditioned and/or stored in an appropriate large volume container such as a tank or a drum, typically a container of at least 5 L, preferably at least 10 L, for example in a tank or drum of at least 100 L, for example of from 400 to 1000 L.

### Use—Fermented Milk Products

The composition of the invention is typically used in a food product. It is typically added to a food product intermediate, to provide a final food product. The invention also concerns such final food products comprising the added composition of the invention, and processes to prepare such final food products. The composition is thus an intermediate that can provide calcium supplementation, as well as other supplementations and/or as well as taste organoleptic modification, to the food product. Compositions according to the invention for additions to food products are often referred to as fruit preparations or as slurries.

The composition can be added in an amount of from 5 to 30% by weight, preferably from 5 to 25%, with reference to the total weight of the food product.

The food product can be for example:
a fermented milk product, for example a yogurt, a fresh cheese, a cheese,
a non-fermented milk-based dessert,
a vegetal milk substitute, for example soy milk, rice milk, oat milk, almond milk or a mixture thereof,
a fermented vegetal milk substitute product, for example a fermented soy product,
a non-fermented vegetal milk substitute dessert, for example a soy dessert,
a fruit product such as a fruit juice, a smoothie, a compote, or a puree,
a frozen dessert, for example an ice-cream, a sorbet, or a frozen yogurt.

The food product can be in the form of a liquid drink, a viscous spoonable product, a mousse, or a solid product such as a frozen product.

Such food products and additions of compositions such as fruit preparations to such food products are known by the one skilled in the art.

Desserts, either milk-based or vegetal milk substitute-based are typically heat treated products, usually comprising gelling agents, and comprising organoleptic modifiers such as vanilla flavor, chocolate etc. . . . . They can be for example in the form or a flan, a gel, a cream or a mousse.

Herein milk typically refers to animal milk, for example cow milk. Some alternative animal milks can be used, such as sheep milk or goat milk. The milk of the food product can be for example full milk, partially or totally skimmed milk, skimmed milk powder etc. . . . . The milk of the food product can be introduced completely or partly in a milk powder form, mixed with water or with liquid milk.

The food product can be a fermented milk product, or a fermented vegetal milk substitute product. Fermented products typically comprise microorganisms, such as lactic acid bacteria and/or probiotics (the probiotics can be lactic acid bacteria), dead or alive. These are also referred to as ferments or cultures or starters. Lactic acid bacteria are known by the one skilled in the art. Probiotics are also known by the one skilled in the art. Examples of probiotics include some Bifidobacteria and Lactobacilli, such as Bifidobacterium brevis, Lactobacillus acidophilus, Bifidobacterium animalis, Bifidobacterium animalis lactis, Bifidobacterium infantis, Bifidobacterium longum, Lactobacillus casei, Lactobacillus casei paracasei, Lactobacillus reuteri, Lactobacillus plantarum, or Lactobacillus rhamnosus. In one embodiment the product is a fermented milk product or a yogurt. It is mentioned that yogurts are considered as being specific fermented milk products.

Fermented milk products are known by the one skilled in the art. Such products are made from milk, either animal milk or vegetal milk substitute (with further additives), and have undergone a fermentation step. The fermentation is typically done by microorganisms such as bacteria and/or yeasts, preferably at least bacteria, preferably lactic acid bacteria, and leads to the production of fermentation products, for example lactic acid, and/or to the multiplication of the microorganisms. The designation “fermented milk” can depend on local legislation, but is typically given to a dairy product prepared from skimmed or full fat milk, or concentrated or powdered milk, having undergone a heat treatment at least equivalent to a pasteurization treatment, and inoculated with lactic acid producing microorganisms such as Lactobacilli (Lactobacillus acidophilus, Lb. casei, Lb. plantarum, Lb. reuteri, Lb. johnsonii), certain Streptococci (Streptococcus thermophilus), Bifidobacteria (Bifidobacterium bifidum, B. longum, B. breve, B. animalis) and/or Lactococci (Lactococcus lactis).

If the food product is a fermented food product, it typically comprises lactic acid bacteria. The lactic acid bacteria typically comprise a mixture of Streptococcus thermophilus and Lactobacillus delbrueckii subsp. Bulgaricus.

The fermented milk product can be a set product, wherein fermentation occurs in the packaging, or a stirred or drink product, wherein fermentation occurs in a tank, prior to adding fruit preparations and stirring to lower the viscosity and to pack. Fermented milk products, before the addition of the composition of the invention, can be referred to as “white masses”. The pH of the white mass and/or of the final food product can be for example of from 3.5 to 5, preferably from 4 to 5, preferably from 4.2 to 4.9.

Thus in a preferred embodiment the food product is a fermented milk product and is prepared as follows:
step A) preparing a white mass product,
step B) adding the composition to the white mass.

As mentioned above, Step A) typically comprises a step of fermenting milk with lactic acid bacteria.

In a preferred embodiment step B) comprises a step of stirring. Depending of the intensity of stirring, the final fermented milk product can be thus a stirred spoonable product or a drinkable product.

The food product can for example have a calcium content, for 100 g of product, of from 125 mg to 1200 mg, preferably of from 130 mg to 600 mg, for example of from 130 mg to 150 mg, or from 150 mg to 200 mg, or from 200 mg to 250 mg, or from 250 mg to 300 mg, or from 300 mg to 350 mg, or from 350 mg to 400 mg, or from 400 mg to 450 mg, or from 450 mg to 500 mg, or from 500 mg to 550 mg, or from 550 mg to 600 mg. The calcium content of the composition (provided by the first salt and the second salt if present) and the amount thereof can be adjusted to meet these contents in the food product.

In one embodiment the food product comprises vitamin D, typically introduced in the composition. The food product can have for example a vitamin D content, for 100 g of product, of from 0.5 μg to 15 μg, preferably of from 1 to 10 μg, preferably of from 1.5 to 8 μg, for example of from 1.5 to 2 μg, or from 2 to 2.5 μg, or from 2.5 to 3 μg, or from 3 to 3.5 μg, or from 3.5 to 4 μg, or from 4 to 4.5 μg, or from 4.5 to 5 μg, or from 5 to 5.5 μg, or from 5.5 to 6.5 μg, or from 6.5 to 7 μg, or from 7 to 7.5 μg, or from 7.5 to 8 μg.

In some specific embodiments, the contents of calcium and vitamin D, for 100 g of product, are as follows:
320 mg≦calcium≦1200 mg and 4 μg≦vitamin D≦10 μg.
150 mg≦calcium<320 mg and 4 μg≦vitamin D≦10 μg, or
275 mg≦calcium and 1.6 μg≦vitamin D<4 μg, or
150 mg≦calcium<275 mg and 3.05 μg≦vitamin D<4 μg, or
150 mg≦calcium<275 mg and 1.6 μg≦vitamin D<3.05 μg.

Of course the food product is typically filled in a container, such as a bottle, or carton pack, a pot or a cup, which container is then sealed, to obtain a finished product. Sealing can be performed for example with a cap or with a lid. The container can be for example a container of 50 ml (or 50 g), to 1 L (or 1 kg), for example a container of 50 ml (or 50 g) to 80 ml (or 80 g), or 80 ml (or 80 g) to 100 ml (or 100g), or 100 ml (or 100 g) to 125 ml (or 125 g), or 125 ml (or 125 g) to 150 ml (or 150 g), or 150 ml (or 150 g) to 200 ml (or 200 g), or 250 ml (or 250 g) to 300 ml (or 300 g), or 300 ml (or 300 g) to 500 ml (or 500 g), or 500 ml (or 500 g) to 750 ml (or 750 g), or 750 ml (or 750 g) to 1 L (or 1 kg). Containers of up to 300 ml, preferably up to 125 ml, are considered as small size containers. The container defines a serving of the food product.

The amount of calcium in the serving can be for example of from 120 to 240 mg for food products adapted for kid consumption, or from 350 to 500 mg for food product adapted for senior consumption, for example for women aged of at least 45 year or of at least 50 years, or for men or women aged of at least 60 years. The concentration of calcium in the food product can be adjusted to meet the calcium content of the serving.

The food product can be stored, transported and/or distributed at room temperature or at a chilled temperature of 0° C. to 10° C., preferably of 4° C. to 10° C., or at a frozen temperature of from −25° C. to −0.5° C., preferably from −25° C. to −15° C., preferably from −25° C. to −18° C. Storage, transport and distribution temperatures can depend on the food product, the treatments thereof such as pasteurization or sterilization and/or the intended self life. Fermented milk products are preferably stored, transported and/or distributed at a chilled temperature.

The food product is typically to be used by oral administration. One can typically eat or drink the food product by processing it from a container to the mouth, optionally using a spoon, a glass, or a straw.

Further details or advantages of the invention might appear in the following non limitative examples.

### EXAMPLES

In the following examples the letter C designates a comparative example.

### Example 1

### Preparation of Compositions

The following ingredients are used:
tricalcium phosphate (TCP): tricalcium phosphate micro fine powder marketed by Budenheim
monocalcium phosphate (MCP): monocalcium phosphate monohydrate fine powder, marketed by Budenheim
tricalcium citrate (TCC): micronized tricalcium citrate, marketed by Jungbunzlauer
Starch: Hydroxypropyl distarch phosphate, marketed as National Starch 465 by National Starch
Guar Gum: Grinsted guar marketed by Danisco
Fruits: Strawberry cubes IQF 10>10 mm or Strawberry concentrated ×3 Aseptic
Citric acid monohydrate
Trisodium citrate dihydrate
Phosphoric acid 75% solution
Flavour: typical strawberry, typical vanilla
Color: carmine 4% sol.

The compositions provided in Table I are prepared, using the preparation procedure below. The amounts are provided as weight % of ingredient as such. The brix degree, calcium content and molar ratio of first salt and acidification compound are indicated.

### Procedure Examples 1.1 to 1.7

Preparing a fruit mix by mixing fruit, sugar (or High Impact Sweeteners), water

Preparing a mixture in water of TCP, and MCP

Adding the mixture of TCP and MCP to the fruit mix
Adding the stabilizing system

Pasteurizing (90° C./5 min)

Adding color and flavor

Cooling to 20° C.

### Procedure Examples 1.8 C and 1.9

Preparing a fruit mix by mixing fruit, sugar (or High Impact Sweeteners), water

Preparing a dispersion in water of TCP

Adding the solutions or dispersions to the fruit mix

Adding the stabilizing system

Pasteurizing (90° C./5 min)

Ajust pH to the target with citric acid or phosphoric acid

Adding color and flavour

Cooling to 20° C.

TABLE I

| Example | 1.1 | 1.2 | 1.3 | 1.4 | 1.5 | 1.6 | 1.7 | 1.8C | 1.9 |
|---|---|---|---|---|---|---|---|---|---|
| Strawberry pieces | / | / | 45 | 45 | / | / | / | / | / |
| Strawberry puree concentrated x3 | / | 13.55 | | | | | 10 | 10 | 10 |
| monocalcium phosphate | 5.53 | 3.45 | 4.8 | 3.45 | 9 | 10.4 | 5.53 | / | / |
| Monohydrate | | | | | | | | | |
| tricalcium phosphate | 3.74 | 2.1 | 4.1 | 2.1 | 7.77 | 4.1 | 3.74 | 6.47 | 6.47 |
| tricalcium citrate | / | / | / | / | / | / | / | / | / |
| Starch E1442 | 3.5 | 2.9 | 3 | 2.7 | 3.3 | 3.5 | 3 | 3 | 3 |
| Guar gum | / | 0.5 | / | 0.2 | / | / | / | / | / |
| Flavour | / | Strawberry | Strawberry | Strawberry | na | na | Strawberry | Strawberry | Strawberry |
| Color | / | Red | red | red | na | na | Red | Red | / |
| Fructose | / | 18 | / | / | / | / | | | |
| Sugar | / | 12.8 | / | 20 | / | / | | | |
| Sucralose | 0.134 | / | 0.134 | / | 0.134 | 0.134 | | | |
| AcesulfamK | 0.003 | / | 0.003 | / | 0.003 | 0.003 | 0.058 | 0.058 | 0.058 |
| Aspartam | / | / | / | / | / | / | 0.086 | 0.086 | 0.086 |
| Citric acid | / | / | / | / | / | / | / | 2.5 | / |
| Phosphoric acid | / | / | / | / | / | / | / | / | 1.2 |
| Water | 87.09 | 46.70 | 42.96 | 26.55 | 79.79 | 81.86 | 77.59 | 77.89 | 80.39 |
| Brix | 27 | 40.5 | 8.3 | 27.8 | 3.9 | 5.5 | 4.6 | 7.2 | 7.5 |
| Calcium content g/100 g | 2.15 | 1.26 | 2.16 | 1.26 | 4.07 | 3.05 | 2.15 | 2.20 | 2.20 |
| Molar ratio salt/acidification | 0.53 | 0.47 | 0.67 | 0.47 | 0.67 | 0.31 | 0.53 | / | 1.70 |
| compound | | | | | | | | | |
| pH at D 0 (20° C.) | 3.55 | 3.48 | 3.85 | 3.53 | 3.39 | 2.65 | 3.46 | 3.53 | 3.87 |
| pH at D 10 (20° C.) | 3.61 | 3.5 | 3.98 | 3.67 | 3.49 | 2.85 | 3.67 | 3.85 | 3.92 |
| pH at D 21 (20° C.) | 3.4 | 3.55 | 4.04 | 3.6 | 3.56 | 2.65 | 3.47 | 3.81 | 3.92 |
| pH at D 35 (20° C.) | 3.4 | 3.6 | 4.05 | 3.58 | 3.62 | 2.67 | 3.45 | 3.83 | 3.93 |
| Maximum pH variation | 0.21 | 0.12 | 0.2 | 0.14 | 0.23 | 0.2 | 0.22 | 0.32 | 0.06 |

Evaluation

The pH stability is tested during 35 days (shelf life) at ambient temperature (20° C.). The values at Day 0 (D0), Day 10 (D10), Day 21 (D21) and Day 35 (D35) are reported in table I. The maximum variation is also reported. Compositions having a pH variation of up to 0.25 are considered as stable.

Example 1.8C shows that an association of citric acid and tricalcium phosphate does not allow a good stability of the composition. Moreover a high amount of citric acid was required to reach the desired pH, which leads to a too high acidic taste.

The aspect of the compositions is also checked during this period. All of the compositions remain homogeneous.

### Example 2

### Preparation of Fermented Milk Products

The compositions reported in Table II are prepared.

TABLE II

| | Example | | |
|---|---|---|---|
| | 1.7 | 2.1C | 2.2C |
| Strawberry pieces | / | / | / |
| Strawberry puree concentrated | 10 | 10 | 10 |
| x3 | | | |
| monocalcium phosphate | 5.53 | / | / |
| monohydrate | | | |
| tricalcium phosphate | 3.74 | / | / |
| tricalcium citrate | / | 10.45 | / |
| Starch E1442 | 3 | 3 | 3 |
| Guar gum | / | / | / |
| Flavour | Strawberry | Strawberry | Strawberry |
| Color | Red | Red | Red |
| Fructose | / | / | / |
| Sugar | / | / | / |
| Sucralose | / | / | / |
| AcesulfamK | 0.058 | 0.058 | 0.058 |
| Aspartam | 0.086 | 0.086 | 0.086 |
| Citric acid | / | 0.35 | 0.25 |
| Sodium Citrate | / | 0.05 | 0.05 |
| Phosphoric acid | / | / | / |
| Water | 77.59 | 76.01 | 86.56 |
| Brix | 4.6 | 11.5 | 11.5 |
| Calcium content g/100 g | 2.15 | 2.19 | / |
| Molar ratio salt/acidification | 0.53 | / | / |
| compound | | | |
| pH at D0 (20° C.) | 3.46 | 3.9 | 3.7 |
| pH at D10 (20° C.) | 3.67 | 3.89 | 3.69 |
| pH at D21 (20° C.) | 3.47 | 3.89 | 3.73 |
| pH at D35 (20° C.) | 3.45 | 3.84 | 3.71 |
| Maximum pH variation | 0.22 | 0.1 | 0.1 |

The compositions of table II are introduced in a fermented milk product (white mass) in the proportions below to obtain a final product.
White mass: 80%
Composition: 20%.

The white mass is a 0% fat white mass obtained by fermentation of a mixture of skim milk and skim milk concentrate.

The final product is a 0% fat stirred yogurt containing 500 mg Calcium per 100 g serving.

The 3 products are subjected to a sensorial analysis by a panel of 15 trained experts.

The 3 products are considered as very close:

There is no difference of thickness with spoon and in mouth between the products.

There is no increase of chalkiness, acidity, astringency, and off-notes with introduction of calcium.

These evaluations show that the introduction of the calcium phosphate salts according to the invention allows obtaining products with sensory profiles that are equivalent to those of products obtained with calcium citrates.

1. A composition comprising:
water
a first salt comprising Ca²⁺ ions and PO₄³⁻ ions or HPO₄²″ ions, optionally in a hydrated or hydroxylated form,
an acidification compound selected from phosphoric acid or a second salt of Ca²⁺ ions and H₂PO₄″ ions, optionally in a hydrated form,
a stabilizing system having at least one stabilizer,
optionally at least one organoleptic modifier selected from aromas, flavors, sugars, sweetening agents, coloring agents, fruits, fruit extracts, cereals and/or cereal extracts, wherein:
the total amount by weight of calcium from the first salt and the second salt, if present, is from 0.1% to 10%, preferably from 0.5% to 4.5%, preferably from 1% to 3%, and
the molar ratio between the first salt and the acidification compound is from 0.1 to 2, preferably from 0.1 to 1 , preferably from 0.25 to 0.75.

2. A composition according to claim 1 , wherein the first salt is tricalcium phosphate (TCP) or hydroxyapatite.

3. A composition according to claim 1, wherein the second salt is monocalcium phosphate (MCP) or monocalcium phosphate monohydrate (MCP MH).

4. A composition according to claim 1, wherein the first salt is tricalcium phosphate and the acidification compound is monocalcium phosphate monohydrate (MCP MH).

5. A composition according to claim 1, wherein at least a part of the first salt is in the form of particles, and wherein the particles have a size repartition with a D₉₀ size of lower than 20 μm, preferably of lower than 10 μm, and preferably a D₅₀ size of lower than 10 μm, preferably of lower than 5 μm.

6. A composition according to claim 1, having a pH at 20̂ from 2.5 to 5, preferably of from 2.8 to 4.2.

7. A composition according to claim 1, wherein the stabilizing system or stabilizer is a starch, a pectin, a guar, a xanthan, a carrageenan, a locust bean gum, or a mixture thereof.

8. A composition according to claim 1, wherein the amount of stabilizing system is from 0.5 to 5% by weight.

9. A composition according to claim 1, having a brix degree from 1 to 65 brix.

10. A composition according to claim 1, wherein the amount of water is from 10 to 99%, preferably from 10 to 87%.

11. Process for making a product according to claim 1 comprising the steps of:
Step 1) mixing the first salt and at least a part of the water to obtain an aqueous premix, Step 2) mixing the aqueous premix, the stabilizing system, the optional organoleptic modifier, and the remaining water if any,
wherein the acidification compound is mixed at step 1) if the acidification compound is the second salt, and wherein the acidification compound is mixed at step 1) or step 2) if the acidification compound is phosphoric acid.

12. A process according to claim 11, comprising a pasteurization step.

13. The use of the composition according to claim 1 in a food product.

14. The use according to claim 13, wherein the food product is a fermented milk product.

15. The use according to claim 13, wherein the composition is added in an amount of from 5 to 30% by weight, with reference to the total weight of the food product.

16. The use according to claim 13, wherein the food product is a fermented milk product and is prepared as follows:
step A) preparing a white mass product,
step B) adding the composition to the white mass.

17. The use according to claim 16, wherein step A) comprises a step of fermenting milk with lactic acid bacteria.
